(19) United States
(12) Patent Application Publication
(10) Pub. No.: US 2017/0296952 A1
(43) Pub. Date: Oct. 19, 2017

(54) METHOD FOR PRE-WETTING PP FILTER FOR FILTERING SLURRY AND PP FILTER PACKAGE

(71) Applicant: MYCROPORE CORPORATION LTD., Zhubei City (TW)

(72) Inventor: Kenneth WONG, Singapore (SG)

(21) Appl. No.: 15/637,440

(22) Filed: Jun. 29, 2017

Related U.S. Application Data
(63) Continuation-in-part of application No. 14/714,827, filed on May 18, 2015.

(30) Foreign Application Priority Data
May 19, 2014 (TW) 103117476

(51) Int. Cl. B01D 37/02; B65D 81/22; B65D 65/40; B01D 29/01; B65B 5/04; B01D 29/58; B65D 85/00; B65B 55/18

(52) U.S. Cl. CPC B01D 37/02; B65D 85/70; B65D 81/22; B65D 65/40; B65B 55/18; B01D 29/014; B65B 5/045; B01D 29/58; B01D 29/016; B01D 2201/0423

(57) ABSTRACT

A method for pre-wetting a polypropylene (PP) filter for filtering slurry and a PP filter package are provided. The method for pre-wetting the PP filter for filter slurry consists of steps of: pre-wetting a PP filtering media of the PP filter and packaging the pre-wetted PP filter in a packaging member sealingly. A PP filter package includes a cartridge, a PP filtering media and a packaging member. The PP filtering media is disposed in the cartridge to form a PP filter. The PP filtering media is pre-wetted, and the PP filter is sealingly packaged in the packaging member.

### BACKGROUND OF THE INVENTION

### Field of the Invention

This application is a Continuation-in-Part of application Ser. No. 14/714827, filed on May 18, 2015, for which priority is claimed under 35 U.S.C. § 120; and this application claims priority of Application No. 103117476 filed in Taiwan on May 19, 2014 under 35 U.S.C. § 119, the entire contents of all of which are hereby incorporated by reference.

### Description of the Prior Art

It is conventional for semiconductor manufacturers to constantly seek improvements in materials and manufacturing processes with the objective to elevate product IC chip yield and to lower production cost. To achieve these objectives, semiconductor manufacturers looks to improve all the factors of production, including the improvement of slurry filtering efficiency of chemical mechanical polishing (CMP) process. CMP is a process to flatten unevenness of a surface of a substrate, including but not limited to semiconductor wafer, in a semiconductor or related manufacturing environment. Slurry used in the CMP process comprises of nano size polishing particles and other chemical substances. When processing the substrate, a processing head rotating in high speed, the slurry including the polishing particles are added on a surface of an substrate to be processed and a predetermined pressure applied to the processing head together make the polishing particles abrade with the surface of the substrate to be processed so as to remove the unevenness of the surface of the substrate and improve the planarization of the substrate. However, if the polishing particles in the slurry forms agglomeration of undesirable large particles, the substrate surface will be scratched when the substrate or wafer is being polished, and some IC chips may be damaged; therefore, the polishing slurry need to be filtered to remove the undesirable large particles, and to ensure only desirable nano polishing particles passes through the filter to reach the surface of the substrate. Usually, the industry uses high-purity PP media with a nominal pore size ranges from 10 μm to 0.1 μm as a filter; and the structure of such PP filter shall include melt blown, non-woven or woven structures.

However, a conventional PP filter of smaller pore size for filtering slurry suffers high pressure drop and filtration performance when it is used directly. Usually, pressure pre-wetting with water or slurry is required before it is being used.

The pore size of PP filter used in an advanced polishing process of semiconductor is below 0.5 μm. PP filter with a pore size below 0.5 μm has high hydrophobicity, an undesirable high pressure drop occurs when the slurry chemical is forced to pass through such tight filtering media. Therefore, the filter needs to be pre-wetted to change a surface tension of the filter media to render the filter hydrophilic so as to be used in the filtering process. Usually, the filter is pre-wetted before being used; however, if the time of pre-wetting is untimely or too long, production may be affected. Furthermore, if a pre-wetting process is not appropriate or not consistent, production quality of the semiconductor will be affected. The above-mentioned situations make it increasingly more time-consuming and challenging to use conventional non prewet PP filter for filtration of slurry for increasingly advanced CMP process in semiconductor manufacturing. As disclosed in prior arts U.S. Pat. No. 4,727,705 and U.S. 20020060179, these are different methods used to sterilize, pre-wet and package a PTFE hydrophobic membrane filter normally intended for filtering strong acid or alkaline fluids used in semiconductor manufacturing; however, PP filter for slurry filtration is not within the scope of the inventions.

U.S. Pat. No. 5,928,516 discloses that a filter and a noncontaminating liquid are placed in a container, such as a bag, to immerse the filter in the noncontaminating liquid. After the bag is closed to prevent liquid or microorganisms from entering it, the filter and the noncontaminating liquid are sanitized and preferably sterilized while in the bag. That is, the filter is sanitized and sterilized after sealingly packaged in the bag. As a result, debris or dregs produced due to sanitization and sterilization and impurities in the liquid are remained in the bag. It is noted that debris, dregs and impurities can come into and contaminate the filter easier and the filtering efficacy of the filter is deteriorated since the filter is pre-wetted.

The present invention has arisen to mitigate and/or obviate the afore-described disadvantages.

### SUMMARY OF THE INVENTION

The major object of the present invention is to provide a method for pre-wetting a polypropylene (PP) filter for filtering slurry and a PP filter package, wherein the filter can be pre-wetted before being sealingly packaged in a packaging member, so the filter can stay wet before a user opens and uses it. The user can use the pre-wetted filter directly, and the pre-wetted filter has a lower pressure drop compared to that of non pre-wetted filter, and the pre-wetted filter maintains a steady flow rate of the slurry fluid so that the production quality is elevated, and wastage of slurry is minimized.

To achieve the above and other objects, a method for pre-wetting a PP filter for filtering slurry is provided, consisting of steps of: pre-wetting a PP filtering media of the PP filter and packaging the pre-wetted PP filter in a packaging member sealingly.

To achieve the above and other objects, a PP filter package is further provided, including a cartridge, a PP filtering media and a packaging member. The PP filtering media is disposed in the cartridge to form a PP filter, and the PP filtering media is pre-wetted. The PP filter is sealingly packaged in the packaging member.

The present invention will become more obvious from the following description when interpreted in connection with the accompanying drawings, which show, for purpose of illustrations only, the preferred embodiment(s) in accordance with the present invention.

### BRIEF DESCRIPTION OF THE DRAWINGS

FIG. 1 is a drawing showing a preferred embodiment of the present invention;

FIG. 2 is another drawing showing the preferred embodiment of the present invention;

FIG. 3 is a cross-sectional drawing of another embodiment of the present invention;

FIG. 4 is a drawing showing a test result of an embodiment of the present invention; and

FIG. 5 is another drawing showing another test result of an embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

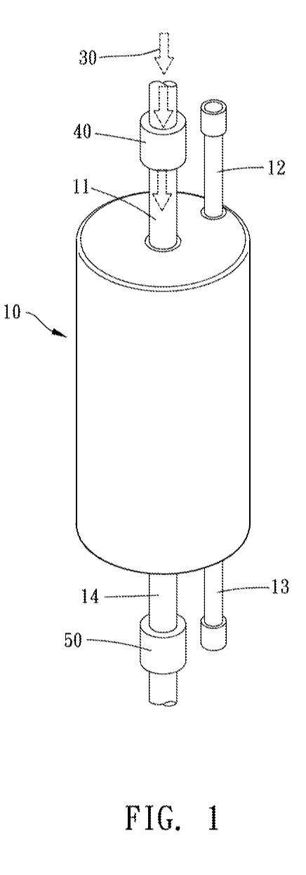

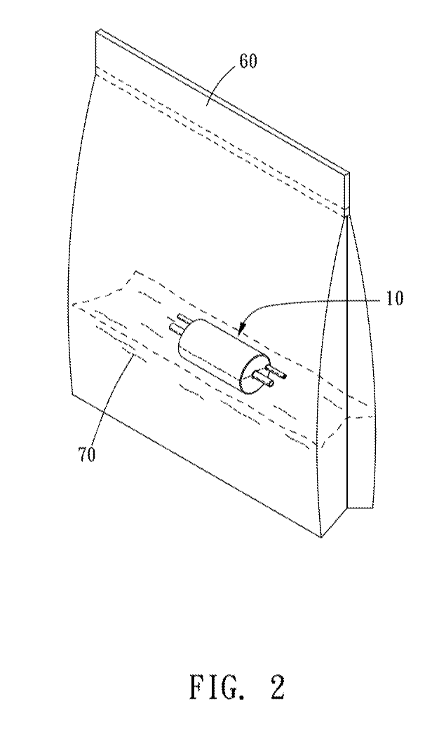

Please refer to FIGS. 1 and 2 for a preferred embodiment of the present invention. A method for pre-wetting a PP filter 10 for filtering slurry including steps of: pre-wetting a PP filtering media 20 of the PP filter 10 with a pre-wetting liquid 30 and flushing the PP filtering media 20 wetted with deionized water. In this embodiment, the PP filter 10 may include a feed-in end 11 for feeding in the hydrophilic pre-wetting liquid 30. The pre-wetting liquid 30, for example, may be a combustible liquid, ethanol or isopropanol alcohol (IPA). Preferably, the pre-wetting liquid 30 is fed in the feed-in end 11 through a connecting head 40 having a sealing device. Specifically, the connecting head 40 is provided with a sealing ring; therefore, when the connecting head 40 is assembled to the feed-in end 11, the pre-wetting liquid 30 is fed in the PP filter 10 without being exposed to outside so as to prevent dust and particles of the outside from entering an interior of the PP filter 10.

The PP filter 10 may further has two exhaust openings 12, 13, and the two exhaust openings 12, 13 are located at an upper end and a lower end of the PP filter 10 respectively. When the pre-wetting liquid 30 is fed in the PP filter 10, air is squeezed and discharged to outside through the two exhaust openings 12, 13. Preferably, the pre-wetting liquid 30 can be controlled to be fed in the PP filter 10 in a predetermined and relatively lower flow rate to avoid producing air bubbles. The air inside the PP filter 10 is discharged to outside completely so that the PP filter 10 contains the pre-wetting liquid 30, and the PP filtering media 20 is drenched completely to make the PP filtering media 20 hydrophilic. Preferably, after the PP filtering media 20 is drenched completely for a predetermined time, the PP filtering media 20 can achieve preferable hydrophilicity.

The PP filter 10 may further include a feed-out end 14 for discharging the pre-wetting liquid 30. Preferably, the feed-out end 14 may be connected with a valve set 50, and the valve set 50 is provided for controlling the discharging of the pre-wetting liquid 30. When the pre-wetting liquid 30 wets the PP filtering media 20 completely, and after a predetermined time, the valve set 50 can be opened for discharging the pre-wetting liquid 30. The valve set 50 may further be connected with a feed-in end of another PP filter or discharged to drain. After the pre-wetting liquid 30 is discharged out of the PP filter 10 completely, ultrapure deionized water is fed in through the feed-in end 11 to flush the PP filtering media 20 wetted and to pre-wet the PP filtering media 20, and then, the deionized water used is discharged through the feed-out end 14.

It is to be noted that the PP filter 10 may be formed without the feed-in end 11, the two exhaust openings 12, 13 and the feed-out end 14. The PP filtering media 20 can be immersed in a container having the pre-wetting liquid 30 to be drenched completely so as to wet the PP filtering media 20. After a predetermined time, the PP filtering media 20 can be taken out from the container having the pre-wetting liquid 30 and further immersed in a container having the deinoized water to pre-wet the PP filtering media 20.

The pre-wetted PP filter 10 is sealingly packaged in a packaging member 60. Before the PP filter 10 is sealingly packaged in the packaging member 60, the PP filter 10 is further sterilized. Specifically, the pre-wetted PP filter 10 may be packaged in a double-layer plastic bag, and the double-layer plastic bag has, for example, an inner layer made of polypropylene and an outer layer made of Mylar.

Preferably, the packaging member 60 further contains liquid water 70 to keep the pre-wetted PP filtering media 20 wet. The PP filter 10 can be sterilized through high temperature steam to prevent bacteria on the pre-wetted PP filter 10 from influencing the quality of the PP filter 10.

Finally, the packaging member 60 can be sealed by hot melt. The PP filter 10 stays wet before being opened and used, so the user can assemble the pre-wetted PP filter 10 to a polishing equipment directly to save the time cost of pre-wetting. In addition, the pre-wetted filter can lower the pressure drop of a liquid after being filtered so that the slurry can maintain a predetermined flow rate from the beginning to the end of the effective filtration life, without wasting slurry.

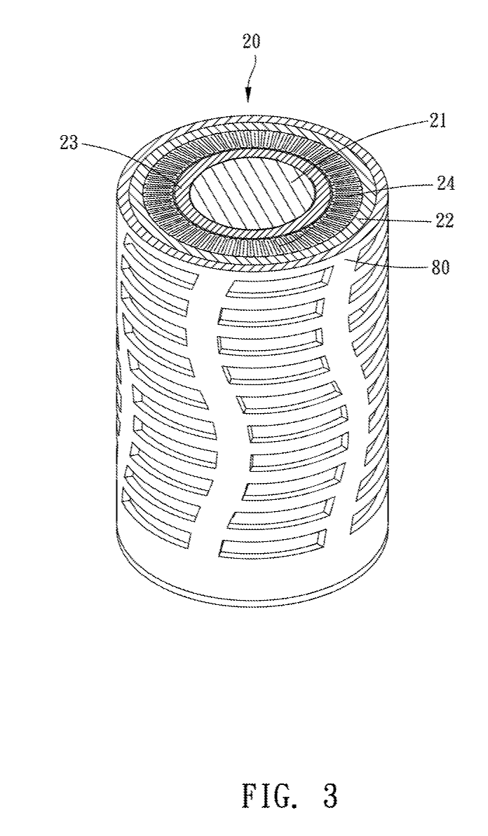

Please refer to FIG. 3 for a pre-wetted PP filter package, including a cartridge 80 and a PP filtering media 20. The PP filtering media 20 is disposed in the cartridge 80 to form a PP filter, and the PP filtering media 20 is pre-wetted. The cartridge 80, for example, may be a long cylindrical cartridge. The PP filtering media 20 is cylindrical and includes an inner layer 21, an outer layer 22, a wrapped layer 23 adjacent to the inner layer 21 and a pleated layer 24 adjacent to the outer layer 22. The wrapped layer 23 is laminatedly arranged about an axis of the PP filtering media 20, and the pleated layer 24 is continuously pleated circumferentially relative to the axis.

The inner layer 21 and the outer layer 22 are flow guiding layers, the pleated layer 24 is used to filter larger particles, and the wrapped layer 23 is mainly used to sieve out polishing particles in a predetermined dimension. Preferably, when the PP filtering media 20 is pre-wetted, a dimension of each pore of the PP filtering media 20 is smaller than 0.5 μm so that the polishing particles after being filtered are appropriate to be used in a manufacturing process of a semiconductor. In addition, a filtering system with multiple layers can elevate the filtering effect. The PP filter for filtering slurry is pre-wetted and packaged (the packaging member sealed may contain liquid water) with the above-mentioned steps so that the pre-wetted PP filter can stay wet before being opened and used.

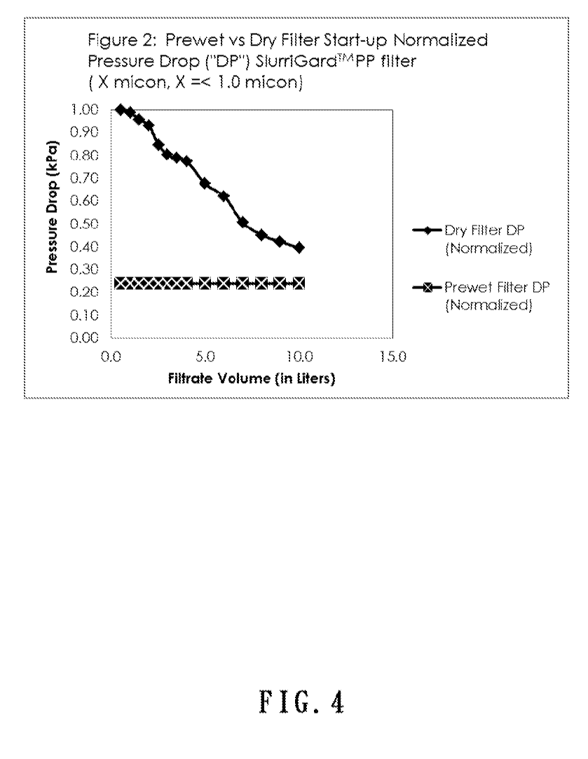

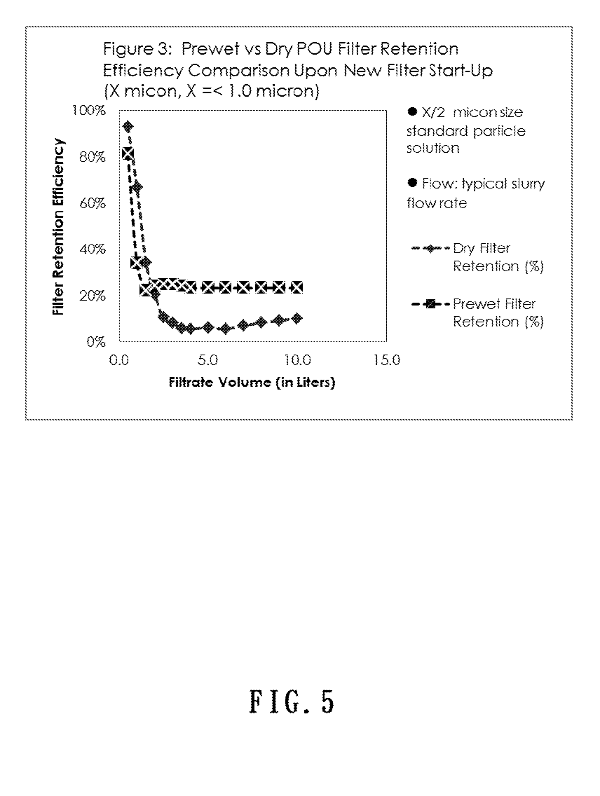

Please refer to FIGS. 4 and 5 for test results of the pre-wetted PP filter and a dry filter which is not pre-wetted. The comparison of the pressure drops of the PP filter and the dry filter is shown in FIG. 4. It is obvious that compared with the dry filter, the pre-wetted PP filter has a more stable and smaller pressure drop. The pre-wetted PP filter can be used, for example, to filter a liquid and allow the liquid to easily flow through upon start-up of a process, and to quickly achieve desired set-point flow rate, and filtered liquid quality. The comparison of the filter retention efficiency of the PP filter and the dry filter is shown in FIG. 5. It is obvious that compared with the dry filter, the pre-wetted PP filter has a more consistent and preferred filter retention efficiency characteristic. In actual practice, the pre-wetted PP filter can be used to filter liquid to produce consistent filtered liquid quality and continuously, thus allowing the user to have better control over advanced manufacturing processes.

In an exemplary embodiment, a method for pre-wetting a polypropylene (PP) filter for filtering slurry consists of following steps in order: wetting a PP filtering media with combustible liquids, ethanol or isopropyl alcohol (IPA); flushing the PP filtering media wetted; pre-wetting the PP filtering media with deionized water, wherein when the PP filtering media is pre-wetted, nominal pore size of the PP filtering media is smaller than 0.5 μm; disinfecting or sterilizing the PP filter pre-wetted; and packaging the PP filter which is disinfected or sterilized in a packaging member sealingly.

Given the above, the method for pre-wetting the PP filter for filter slurry makes the PP filter pre-wetted before the PP filter is sealingly packaged in the packaging member so that the PP filter can stay wet before the user opens and uses it. The user can assemble the pre-wetted PP filter to the equipment directly to save the time and associated cost of pre-wetting. In addition, the pre-wetted PP filter can lower the pressure drop of a liquid after being filtered in the equipment and maintain a steady flow rate of the liquid. Since the PP filter is sanitized and sterilized before sealingly packaged in the packaging member, debris or dregs produced due to sanitization and sterilization and impurities in the liquid are not brought into the packaging member, and the PP filter cannot be contaminated and the filtering efficacy of the PP filter will not be deteriorated.

While we have shown and described various embodiments in accordance with the present invention, it should be clear to those skilled in the art that further embodiments may be made without departing from the scope of the present invention.

What is claimed is:

1. A method for pre-wetting a polypropylene (PP) filter for filtering slurry, consisting of following steps in order:
wetting a PP filtering media with combustible liquids, ethanol or isopropyl alcohol (IPA);
flushing the PP filtering media wetted;
pre-wetting the PP filtering media with deionized water, wherein when the PP filtering media is pre-wetted, nominal pore size of the PP filtering media is smaller than 0.5 μm;
disinfecting or sterilizing the PP filter pre-wetted; and
packaging the PP filter which is disinfected or sterilized in a packaging member sealingly.

2. The method for pre-wetting the PP filter for filtering slurry of claim 1, wherein the packaging member contains liquid water.
